(19) United States
(12) Patent Application Publication
(10) Pub. No.: US 2024/0009683 A1
(43) Pub. Date: Jan. 11, 2024

(54) FLOTATION METHOD AND FLOTATION SYSTEM

(71) Applicant: SUMITOMO METAL MINING CO., LTD., Tokyo (JP)

(72) Inventors: Hayato Fujita, Niihama-shi (JP); Yuji Aoki, Niihama-shi (JP)

(73) Assignee: SUMITOMO METAL MINING CO., LTD., Tokyo (JP)

(21) Appl. No.: 18/267,113

(22) PCT Filed: Aug. 24, 2021
(86) PCT No.: PCT/JP2021/030960

§ 371 Date: Jun. 14, 2023

(30) Foreign Application Priority Data
Dec. 15, 2020 (JP) 2020-207398
Jun. 25, 2021 (JP) 2021-105851

(51) Int. Cl. B03D 1/24; B03D 1/02

(52) U.S. Cl. CPC B03D 1/24; B03D 1/02; B03D 2201/04; B03D 2201/02; B03D 2203/02

(57) ABSTRACT

The purpose of the present invention is to provide a flotation method with which a flotation treatment can be efficiently performed even when the substance to undergo flotation is fine mineral particles including particles having a particle diameter of about 25 μμm or less. This is a flotation method that separates and recovers mineral particles through a flotation treatment, wherein mineral particles are floated in a liquid to be processed by using minute air bubbles having an air bubble diameter of 200 μm or less and air bubbles having a diameter larger than the minute air bubbles.

### TECHNICAL FIELD

The present invention relates to a flotation method and a flotation system used in the flotation method.

### BACKGROUND ART

A mineral in ore extracted from a mine is broadly divided into a useful mineral (mineral containing a large amount of target metal) and a gangue mineral (mineral containing almost no target metal). An ore concentration treatment is performed as an initial treatment of recovering intended metal from ore. A flotation treatment utilizing a difference between hydrophobicity and hydrophilicity on a mineral surface has been performed widely.

According to a flotation treatment illustrated in FIG. 1, ore extracted from a copper sulfide ore mine is subjected to crushing and grinding (operation of removing an adhering substance, an oxide coating, etc. on a surface of a particle obtained after the crushing) and a resultant mineral powder is formed into a mineral slurry. Then, roughing (flotation treatment in a first stage) and cleaning (flotation treatment in a second stage) are performed to make separation between a float fraction and tailings in each stage. Next, the float fraction is physically separated as a useful mineral and recovered while the tailings (final tailings) are stored in a tailing dam.

During the flotation treatment, the float fraction is separated by introducing air bubbles into the mineral slurry, causing mineral particles having hydrophobic surfaces adhere to the air bubbles, and moving up the air bubbles to a surface of the mineral slurry. The air bubbles including the adhering mineral particles and floating at the surface of the mineral slurry are called “froth”. The “separation as the float fraction” means that the froth is recovered by being overflowed from the surface of the mineral slurry or recovered by being scraped off with a spatula, for example.

During the flotation treatment, mineral particles having hydrophilic surfaces settle in the mineral slurry. As a result of liquid-solid separation, this mineral slurry is separated as tailings. For this reason, for implementation of this flotation treatment, adjustment is made in such a manner as to provide hydrophobicity to a surface of a useful mineral in order for the useful mineral to be recovered as a float fraction.

Air bubbles that can be generated by a commercially available flotator generally have a diameter approximately equal to or greater than some millimeters at minimum. Mineral particles that can easily adhere to air bubbles of such an approximate diameter and can be separated easily as a float fraction have a particle diameter approximately from one-tenth to a fraction of the general diameter of the above-described air bubbles (more specifically, a particle diameter approximately from several tens of micrometers to 200 μm). However, recent reduction in high-grade ore causes reduction in ore that can be separated through an efficient flotation treatment at a particle diameter approximately from 100 μm to 1 mm. Hence, in an increasing number of cases, ore is required to be crushed to a small particle diameter approximately equal to or less than 100 μm (for example, particles having a particle diameter approximately equal to or less than 20 μm).

Even if the above-described mineral particles having a considerably small particle diameter compared to air bubbles existing in a flotator are useful mineral particles having hydrophobic surfaces, these mineral particles cannot adhere to air bubbles of the above-described general diameter (approximately equal to or greater than some millimeters at minimum). Patent Document 1 relates to a device and a method of recovering fine particles containing a radioactive metallic substance, and discloses a technique allowing recovery of fine particles containing the radioactive metallic substance from contaminated turbid water without using an adsorbent or a flocculant, and allowing the fine particles containing the radioactive metallic substance by means of floc, the fine particles containing the radioactive metallic substance by means of floc, large-diameter particles containing substantially no radioactive metallic substance, and treated water containing almost no radioactive metallic substance to be recovered simultaneously within a single tank.

Patent Document 2 discloses a treatment method and a treatment device for oil-containing wastewater allowing reduction in the usage of a flocculant compared to a treatment using floating and separation.

Patent Document 1: Japanese Unexamined Patent Application, Publication No. 2014-032034

Patent Document 2: Japanese Unexamined Patent Application, Publication No. 2009-165915

Non-Patent Document 1: N. N. Rulyov; Combined microflotation of fine minerals: theory and experiment; Mineral Processing and Extractive Metallurgy, Volume 125, 2016, pp. 81-85

Non-Patent Document 2: P. T. L Koh et al.; Modeling attachment rates of multi-sized bubbles with particles in a flotation cell;, Minerals Engineering 21, 2008, pp. 989-993

### DISCLOSURE OF THE INVENTION

### Problems to be Solved by the Invention

The present invention is intended to provide a flotation method allowing a flotation treatment to be performed efficiently even if the treatment is for fine mineral particles including particles having a particle diameter approximately equal to or less than 25 μm.

### Means for Solving the Problems

A flotation method according to the present embodiment is a flotation method of separating and recovering mineral particles through a flotation treatment. The flotation treatment is a treatment of floating the mineral particles in a liquid to be treated containing the mineral particles using minute air bubbles having an air bubble diameter equal to or less than 200 μm and air bubbles having a larger diameter than the minute air bubbles in the liquid to be treated.

A flotation system according to the present embodiment is a flotation system that separates and recovers mineral particles through a flotation treatment.

The system includes:
a minute air bubble generation device that introduces minute air bubbles having an air bubble diameter equal to or less than 200 μm into a liquid to be treated including the mineral particles; and
a flotation device including:
a flotation tank that stores the liquid to be treated and floats the mineral particles to an upper part of the liquid to be treated inside the tank, and
an air bubble generator that introduces air bubbles having a larger diameter than the minute air bubbles into the liquid to be treated.

### Effects of the Invention

According to the present invention, it is possible to efficiently perform a flotation treatment even if the treatment is for fine mineral particles including particles having a particle diameter approximately equal to or less than 25 μm.

### BRIEF DESCRIPTION OF THE DRAWINGS

FIG. 1 shows a flow of a flotation treatment;

FIG. 2 shows a schematic configuration of a flotation apparatus used in a flotation method;

FIG. 3 shows a schematic configuration of a flotation apparatus used in the flotation method;

FIG. 4 shows results of flotation treatments according to Example 1 and Comparative Example 1;

FIG. 5 shows results of flotation treatments according to Example 2 and Comparative Example 2; and

FIG. 6 shows results of flotation treatments according to Example 3 and Comparative Example 3.

### PREFERRED MODE FOR CARRYING OUT THE INVENTION

Generally, bubbles (air bubbles) are gas in a medium surrounded by interfaces. These bubbles include those called fine bubbles having a diameter equivalent to a volume that is equal to or less than 100 μm, those called microbubbles having such a diameter equal to or greater than 1 μm and equal to or less than 100 μm, and those called ultrafine bubbles having such a diameter equal to or less than 1 μm. In the present embodiment, these air bubbles will hereinafter be called minute air bubbles. Here, a diameter equivalent to a volume means a diameter derived from the volume of a bubble on the assumption that the bubble is a spherical shape.

A specific embodiment will be described below in detail. The present invention is not limited in any way to the following embodiment, and changes can be added, if appropriate, in carrying out the present invention within a range in which the purpose of the present invention is not changed.

<Flow of Flotation Treatment>

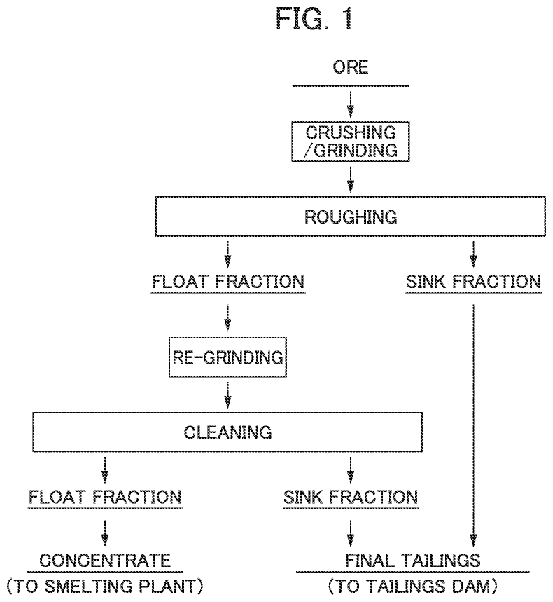

FIG. 1 shows a flow of a flotation treatment that can be performed using a flotation method of the present invention. In the following, the flow of the flotation treatment will be described first and then a specific embodiment of the flotation method of the present invention will be described in detail.

[Crushing/Grinding of Ore]

During the flotation treatment, ore to be treated is crushed to obtain a mixed powder-particle material containing a useful mineral and a gangue mineral. For the separating operation after the crushing to be a physical separation, particles in the mixed powder-particle material are ideally single particles either of the useful mineral or the gangue mineral (hereinafter also called “elemental separation”). The intensity of the crushing is controlled depending on a mineral size in the ore.

In crushing of the ore using a common crushing device such as a ball mill, the mixed powder-particle material can be crushed to a particle size approximately 100 μm at a minimum while economic efficiency is maintained favorably. As a result of recent reduction in mineral size in ore to approximately equal to or less than 25 μm, however, the above-described common crushing to a particle size (particle diameter approximately 100 μm) fails to realize the elemental separation sufficiently. For this reason, an ultrafine crushing device such as a bead mill is used in some cases for crushing to approximately equal to or less than 25 μm.

After the ore is crushed, resultant mineral particles are subjected to a grinding treatment. The grinding is operation of removing an adhering substance, an oxide coating, etc. on a surface of a particle obtained after the crushing. This operation is performed immediately before a flotation treatment (“roughing” or “cleaning” described later) to generate a clean state on the particle surface. By the implementation of this operation, it becomes possible to prevent the occurrence of non-uniformity of an effect brought about by an additive (flotation agent) to be added for the flotation treatment that is, for example, an additive such is a collector, a depressant, or a flocculant targeted for a surface treatment on mineral particles.

[Roughing/Cleaning]

Roughing (rough ore concentration) and cleaning (selected ore concentration) are operations for bringing particles in a mixed powder-particle material obtained by crushing and air bubbles into contact with each other and separating particles to adhere to air bubbles and particles not to adhere to air bubbles from each other using a difference between hydrophilicity and hydrophobicity on particle surfaces, and are principal operations in the flotation treatment.

During the roughing and cleaning operations, the mixed powder-particle material is first mixed with liquid such as water or seawater to be formed into a slurry form (mineral slurry). In preparing ore slurry, a solid content ratio is generally adjusted by giving consideration to efficiency in terms of input of the mineral slurry and the amount of recovered concentrate. Furthermore, in order to increase a difference in wettability between surfaces of useful mineral particles and surfaces of gangue mineral particles, operation of reforming the surface property of slurry to be treated or the property of a liquid phase content to a desired property suitable for the flotation treatment may be performed by adding a flotation agent to the ore slurry, for example. In the present description, such operation of reforming mineral particles will hereinafter be called “conditioning”.

A basic mechanism of the flotation treatment mentioned herein is such that air bubbles are introduced into the mineral slurry, and by utilizing a difference in surface property (wettability) between particles of a useful mineral and particles of a gangue mineral, the air bubbles are caused to adhere to the useful mineral having a hydrophobic surface to recover the useful mineral as a “float fraction” while the gangue mineral is separated as a “sink fraction”.

A flotation agent to be added for the “conditioning” in this treatment includes an agent for changing the property of a mineral surface by adsorbing on its surface and an agent for changing the property of a liquid phase part in the mineral slurry. Examples of a known agent for changing the property of a mineral surface include a collector (such as sodium, xanthate, or ethylxanthate) to apply hydrophobicity to the mineral surface and conversely, a depressant (such as gelatin, lactic acid, or starch) not to apply hydrophobicity to the mineral surface. Examples of a known agent for changing the property of a liquid phase part in the mineral slurry include a pH adjuster (such as hydrochloric acid, hydrogen peroxide water, caustic soda, or lime) for pH adjustment and a frother (such as MIBC, pine oil, or cresylic acid) for generating stable air bubbles by dissolving in the mineral slurry.

During the flotation treatment, particle surface property or a liquid phase in the mineral slurry is adjusted to a proper condition by charging the mineral slurry having been subjected to the “conditioning” in advance into a flotation device, by adding the above-described flotation agent into the slurry, or by performing both of these operations as needed. In some cases, the “conditioning” is performed before introduction of air bubbles while the mineral slurry is charged in the flotation device.

During the flotation treatment, the flotation device agitates the charged mineral slurry and introduces air bubbles, thereby causing the air bubbles to adhere to particles having high hydrophobicity forming a mixed powder-particle material in the slurry. By doing so, the mineral particles adhering to the air bubbles float to a surface of the mineral slurry to form froth. On the other hand, particles of low hydrophobicity sink to become tailings.

For agitation of the mineral slurry, adjustment is made in such a manner as to optimize a device scale, the amount of the mineral slurry to be introduced, a floating speed of air bubbles that are generally adjusted to a size approximately several millimeters, the quantity of the air bubbles to be introduced, etc.

As shown in FIG. 1, the roughing corresponds to a so-called ore concentration treatment in a first stage and the cleaning corresponds to a so-called ore concentration treatment in a second stage. A float fraction obtained by the roughing corresponding to the ore concentration treatment in the first stage is subjected again to a grinding treatment (re-grinding), and then the cleaning corresponding to the ore concentration treatment in the second stage is performed.

<Flotation Method>

A flotation method of the present invention (this may hereinafter be called a “flotation method” simply) is a method of separating and recovering fine mineral particles including particles approximately equal to or less than 25 μm from a liquid to be treated (ore slurry) through a flotation treatment.

During the flotation treatment, introducing minute air bubbles having an air bubble diameter equal to or greater than 50 μm and equal to or less than 200 μm allows fine particles having a particle diameter approximately equal to or less than 25 μm to adhere to the introduced minute air bubbles, thereby forming froth (see Non-Patent Documents 1 and 2). During the flotation treatment targeted for fine mineral particles having a particle diameter approximately equal to or less than 25 μm, however, these minute air bubbles move up at a low speed. In some cases, this causes insufficient generation of the froth and generation of the froth takes a long time.

The “flotation method” of the present embodiment is a process of floating mineral particles as a float fraction in a liquid to be treated (ore slurry) targeted for the flotation treatment using minute air bubbles having an air bubble diameter equal to or less than 200 μm and air bubbles having a larger diameter than the minute air bubbles. A minute air bubble generation device mainly described in the present embodiment is to generate microbubbles. Alternatively, the generated air bubbles may include air bubbles less than 1 μm (ultrafine bubbles).

For example, a device to generate minute air bubbles having an air bubble diameter approximately from 50 to 200 μm can be used. This minute air bubble generation device has a mechanism of generating minute air bubbles of an intended air bubble diameter by forming air supplied into the device into a minute size by passing the air through a porous body and depositing the air externally, and by rotating the porous body to separate air bubbles from a surface of the porous body before the air bubbles become larger.

Preferably, the “air bubbles having a larger diameter than the minute air bubbles” existing in the liquid to be treated together with the minute air bubbles are air bubbles having an air bubble diameter equal to or greater than 1.0 mm and equal to or less than 1.5 mm, for example.

### First Embodiment of “Flotation Method”

The above-described “flotation method” corresponds to an embodiment (first embodiment) in which a minute air bubble generation device is provided as an annex to the foregoing general-purpose flotation device having the function of generating the above-described “air bubbles having a larger diameter than the minute air bubbles”, air bubbles having an air bubble diameter equal to or greater than 50 μm and equal to or less than 200 μm (“minute air bubbles”) are generated in a liquid to be treated (ore slurry) from the minute air bubble generation device, and air bubbles of a larger size than the air bubbles generated from the minute air bubble generation device are generated in the ore slurry from the flotation device.

According to the “flotation method” performed in this way, air bubbles having an air bubble diameter equal to or greater than 50 μm and equal to or less than 200 μm (“minute air bubbles”) and air bubbles of a larger size in air bubble diameter than the minute air bubbles are introduced together. By doing so, the air bubbles having a larger diameter than the minute air bubbles to which mineral particles adhere easily move up at higher speed in the mineral slurry. In response to this, the apparent ascending speed of the minute air bubbles is also increased. As a result, it becomes possible to shorten the time required for the formation of froth.

[Flotation System]

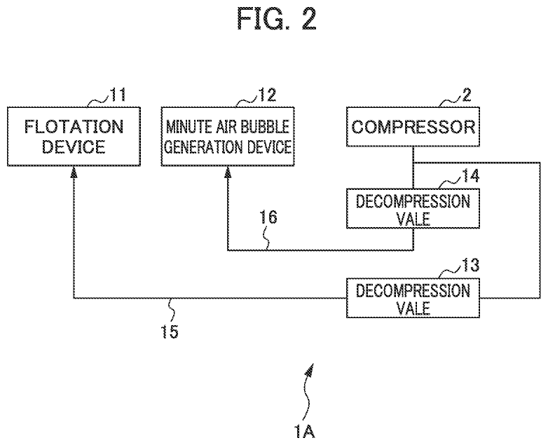

FIG. 2 shows a schematic configuration of a flotation system 1A that can be used preferably in the first embodiment of the flotation method described above. The flotation system 1A includes a flotation device 11 that performs a flotation treatment, and a minute air bubble generation device 12 that is provided as an annex to the flotation device 11, generates minute air bubbles, and introduces the minute air bubbles into a liquid to be treated (ore slurry). In the flotation system 1A, the flotation device 11 and the minute air bubble generation device 12 are individually provided with a decompression valve (flow rate valve) 13 and a decompression valve (flow rate valve) 14 that are respectively connected to the flotation device 11 and the minute air bubble generation device 12 and can regulate flow rates by decompressing pressurized gas supplied from a pressurized gas supply device (compressor) 2.

(Flotation Device)

The flotation device 11 includes a flotation tank in which the flotation treatment is performed on ore slurry containing fine mineral particles supplied into the flotation tank, and an air bubble generator that generates air bubbles and introduces the air bubbles into a liquid to be treated (ore slurry). This flotation device 11 can be configured using a mechanical Denver flotation machine, for example.

Air bubbles having a larger diameter than air bubbles having an air bubble diameter equal to or greater than 50 μm and equal to or less than 200 μm (“minute air bubbles”) generated from the minute air bubble generation device 12 are generated from the flotation device 11, and are introduced into the liquid to be treated (ore slurry) stored in the flotation tank. The air bubble generator generates air bubbles from air taken in from the outside of the device or pressurized gas (pressurized air) supplied from the connected pressurized air supply device. More specifically, while the air bubble diameter of air bubbles generated at the flotation device 11 is not particularly limited as long as it is larger than the minute air bubbles to be introduced (“minute air bubbles”), this air bubble diameter is preferably equal to or greater than 1.0 mm and equal to or less than 2.0 mm.

(Minute Air Bubble Generation Device)

In the flotation system 1A, the minute air bubble generation device 12 is connected as an annex to the flotation device 11. The minute air bubble generation device 12 generates minute air bubbles having an air bubble diameter equal to or greater than 50 μm and equal to or less than 200 μm, which is a smaller size than air bubbles generated from the flotation device 11.

A device to be used as the minute air bubble generation device 12 is not particularly limited as long as it can generate the above-described minute air bubbles. An easily-available and easily-installable general-purpose unit can be used. An example of such a microbubble device may be a microbubble device including a porous body with minute holes provided inside the device and having a mechanism of forming supplied air into a minute size by passing the air through the porous body.

The minute air bubble generation device 12 generates minute air bubbles and introduces the generated minute air bubbles into ore slurry stored inside the flotation device 11. The minute air bubble generation device 12 generates the minute air bubbles from air taken in from the outside of the device or pressurized gas (pressurized air) supplied from the connected pressurized air supply device.

As described above, in the flotation system 1A, providing the minute air bubble generation device 12 as an annex to the flotation device 11 makes it possible to generate minute air bubbles having an air bubble diameter equal to or greater than 50 μm and equal to or less than 200 μm and air bubbles larger in diameter than the minute air bubbles, namely, to generate two types of air bubbles of different sizes in the ore slurry to be treated.

(Decompression Valve)

Preferably, in the flotation system 1A, the flotation device 11 and the minute air bubble generation device 12 are individually provided with the decompression valves (flow rate valves) 13 and 14 respectively that can regulate flow rates by decompressing pressurized gas supplied from the pressurized gas supply device (compressor) 2.

The decompression valves 13 and 14 are regulation valves that decompress pressurized air supplied from the pressurized gas supply device 2 and maintains the air at constant pressure, and can regulate the flow rate of the decompressed air. This allows the decompression valves 13 and 14 to regulate the respective flow rates of air bubbles to be generated from the devices that receive supply of the decompressed air, namely, from the flotation device 11 and the minute air bubble generation device 12. For this reason, the decompression valves 13 and 14 are also called “flow rate valves 13 and 14” that regulate the respective flow rates of air bubbles.

In each of the flotation system 1A and a flotation system 1B, the decompression valves 13 and 14 are individually installed in a connection pipe 15 between the flotation device 11 and the pressurized gas supply device 2 and in a connection pipe 16 between the minute air bubble generation device 12 and the pressurized gas supply device 2 respectively. Thus, it is possible to supply air from the pressurized gas supply device 2 to each of the flotation device 11 and the minute air bubble generation device 12 while respective flow rates of the air are regulated individually for the flotation device 11 and the minute air bubble generation device 12. The respective flow rates of the air to be supplied to the flotation device 11 and the minute air bubble generation device 12 correlate to the flow rates of air bubbles to be generated from the respective devices (11, 12). Thus, exerting control using the decompression valves (flow rate valves) 13 and 14 makes it possible to properly and individually regulate the flow rate of minute air bubbles (air bubbles having an air bubble diameter equal to or greater than 50 μm and equal to or less than 200 μm) and the flow rate of air bubbles having a larger size than the minute air bubbles to be introduced into the ore slurry.

As described above, by introducing minute air bubbles having an air bubble diameter equal to or greater than 50 μm and equal to or less than 200 μm into the mineral slurry containing fine mineral particles, it becomes possible to cause the fine mineral particles to adhere to the introduced air bubbles favorably, thereby forming fine froth. Furthermore, by introducing air bubbles of a larger diameter than the minute air bubbles simultaneously, the air bubbles in a liquid to be treated are caused to ascend at a higher speed in the mineral slurry. In response to this, the apparent ascending speed of the minute air bubbles is increased, so that time required for formation of froth can be shortened.

In this case, the flow rate valves 13 and 14 are provided individually for the flotation device 11 and the minute air bubble generation device 12 respectively to allow the respective flow rates of air bubbles to be generated from the respective devices (11, 12) to be regulate individually. By doing so, it becomes possible to fulfill adhesion of air bubbles to fine mineral particles efficiently and properly and shorten the time required for froth formation resulting from increased speed in floating to a slurry surface.

If a single flow rate valve is provided for the flotation device 11 and the minute air bubble generation device 12, operating the valve for increasing a flow rate at the minute air bubble generation device 12 results in reduction in a flow rate at the flotation device 11, for example. In this case, it is impossible to increase a speed in floating to a slurry surface favorably. Likewise, operating the valve for increasing a flow rate at the flotation device 11 results in reduction in a flow rate at the minute air bubble generation device, for example. In this case, it is impossible to introduce minute air bubbles of a sufficient quantity so the minute air bubbles cannot adhere to fine mineral particles sufficiently, causing reduction in recovery rate of a float fraction.

There is no particular limitation on regulation over the respective flow rates of air bubbles, in other words, on a ratio between the flow rate of minute air bubbles to be generated from the minute air bubble generation device 12 and the flow rate of air bubbles to be generated from the flotation device 11. The flow rates can be set properly in response to the concentration of a solid content (mineral particles) in the mineral slurry to be used for the flotation treatment, the size of these mineral particles, or intended flotation time (time required for froth formation), for example. Furthermore, time required for froth formation differs in response to a viscosity change in a liquid phase of the mineral slurry resulting from addition of a flotation agent or fluctuation in a condition such as a hydrophilicity difference between a useful mineral and a gangue mineral forming mineral particles, for example. Thus, the flow rates are preferably set properly according to these conditions. Moreover, before implementation of the flotation treatment, a flotation test may be conducted as one of operations for the conditioning and a preferred flow rate ratio may be selected based on the test.

If the flow rate of air bubbles (air bubbles generated from the flotation device 11) having a larger diameter than minute air bubbles generated from the minute air bubble generation device 12 is too high, the minute air bubbles move up at an excessively high speed. This may lower a chance for fine mineral particles and these minute air bubbles to contact each other, for example. In another case, even if the minute air bubbles contact and adhere to the fine mineral particles, the minute air bubbles may come off during flotation to a surface of ore slurry.

Regulation over the respective flow rates of air bubbles through control using the flow rate valves 13 and 14 can be carried out by controlling the degrees of opening of the valves.

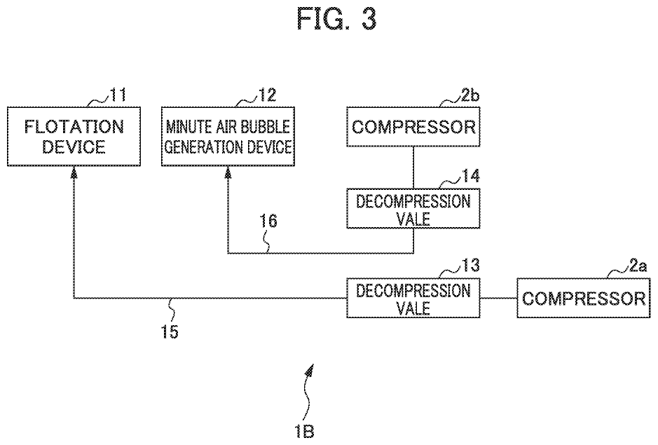

FIG. 3 shows a schematic configuration of the flotation system according to another embodiment to be used in the flotation method. The flotation system 1B includes a flotation device 11 that performs a flotation treatment, and a minute air bubble generation device 12 that is provided as an annex to the flotation device 11, and generates and introduces minute air bubbles. The flotation device 11 and the minute air bubble generation device 12 are individually provided with a decompression valve (flow rate valve) 13 and a decompression valve (flow rate valve) 14 that are respectively connected to the flotation device 11 and the minute air bubble generation device 12 and can regulate flow rates by decompressing pressurized gas. The flotation system 1B differs from the flotation system 1A in that a pressurized gas supply device 2a and a pressurized gas supply device 2b are individually connected to the decompression valves 13 and 14 respectively.

As shown in FIG. 3, in the flotation system 1B, the pressurized gas supply device 2a is connected through a pipe 15 to the flotation device 11 and the flow rate valve 13 is provided in the pipe 15. The pressurized gas supply device 2b is connected through a pipe 16 to the minute air bubble generation device 12 and the flow rate valve 14 is provided in the pipe 16. The pressurized gas supply device 2a and the pressurized gas supply device 2b are separate devices. Air is supplied from each of the devices (2a, 2b) under controls independent of each other to a destination device of connection from the pipe 15 or 16 (flotation device 11 or minute air bubble generation device 12).

In this configuration, the flow rate valves 13 and 14 are also provided in the pipes 15 and 16 respectively to regulate the respective flow rates of air supplied from the pressurized gas supply devices 2a and 2b. This allows the respective flow rates of air bubbles to be generated from the flotation device 11 and the minute air bubble generation device 12 to be regulated individually. By doing so, it becomes possible to efficiently fulfill adhesion of air bubbles to fine mineral particles and shortening of time required for froth formation resulting from increased speed in floating to a slurry surface.

Except for the pressurized gas supply devices 2a and 2b provided separately, the other configuration of the flotation system 1B is the same as that of the flotation system 1A. The other configurations can be shown by applying the foregoing descriptions, thus will not be discussed here.

### Second Embodiment of “Flotation Method”

A “flotation method” of the present embodiment is an embodiment (second embodiment) in which, for implementation of a flotation treatment of floating mineral particles to be treated as a float fraction using a flotation device, minute air bubble containing water containing “minute air bubbles” is poured in advance into a liquid to be treated (ore slurry).

In the second embodiment, the flotation device to be used can also be a general-purpose device having the function of generating air bubbles having an air bubble diameter exceeding 200 μm in a liquid to be treated.

In the second embodiment, water containing minute air bubbles having an air bubble diameter equal to or less than 200 μm may be used without providing the minute air bubble generation device 12 as an annex to the flotation device 11. For example, minute air bubble containing water to be used may be provided as needed to a required amount by the minute air bubble generation device 12 prepared separately. This is not the only case. Water containing minute air bubbles mixed in advance can be obtained from a different place in a factory or from a different factory and the water can be introduced with appropriate timing into the flotation treatment. The technical range of the present invention further covers such an embodiment not involving provision of the minute air bubble generation device 12 as an annex to the flotation device 11.

In implementing the “flotation method” of the second embodiment, if the flotation treatment is to be performed continuously in a plurality of stages as shown in FIG. 1, minute air bubble containing water containing minute air bubbles may be poured to an appropriate amount into a liquid to be treated (ore slurry) to be introduced into a flotation treatment in a first stage (“roughing” in FIG. 1). In another case, for each of the downstream treatments to be performed sequentially such as a flotation treatment in a second stage (“cleaning” in FIG. 1), the minute air bubble containing water may be poured to an appropriate amount, as required, into a liquid to be treated (ore slurry) each time the liquid is introduced into an individual treatment.

According to the second embodiment, like in the case of implementation of the first embodiment, individually regulating the respective flow rates of “minute air bubbles” and “air bubbles having a larger diameter than the minute air bubbles” properly at optimum rates allows implementation of an ore concentration treatment with higher precision.

### EXAMPLES

The present invention will be described below in more detail by giving Examples. However, the present invention is not limited in any way to Examples below.

### Example 1, Comparative Example 1

A mineral to be treated was crushed using a bead mill and sifted to obtain a mixed mineral powder-particle material containing fine mineral particles equal to or less than 20 μm (P80). Table 1 given below shows results of elemental analysis on the resultant mixed powder-particle material (unit: wt %).

TABLE 1

| Cu | S | Fe | SiO₂ |
|---|---|---|---|
| 21.8 | 33.0 | 27.0 | 9.3 |

Next, water was added and mixed into the resultant mixed powder-particle material to obtain a mineral slurry. Calcium hydroxide was added to the mineral slurry to adjust pH to 8.5. Then, conditioning was performed (for one minute) by adding 15 g/t of a frother (methyl isobutyl carbinol: MIBC), 86 g/t of the collector F4244 (available from Flottec, LLC., model number 4244), and 34 g/t of diesel oil (light oil).

Next, the prepared ore slurry was subjected to a flotation treatment in four stages for 30 minutes in total. The flotation treatment according to Example 1 was performed using a flotation apparatus having the schematic configuration shown in FIG. 2. Specifically, the used apparatus includes a minute air bubble generation device (carbon ceramic rotary microbubble generator available from Anzaikantetsu CO, LTD.) provided as an annex to a flotation device.

A mechanical Denver flotation machine was used as the flotation device. Minute air bubbles having a diameter from 100 to 150 μm (“minute air bubbles”) were generated from the minute air bubble generation device. Air bubbles having a larger diameter (diameter from 1.0 to 1.5 mm) than the “minute air bubbles” were generated from the mechanical Denver flotation machine. The respective flow rates of the air bubbles generated from the minute air bubble generation device and the air bubbles generated from the mechanical Denver flotation machine could be regulated.

On the other hand, a flotation treatment performed as Comparative Example 1 was a conventional treatment using an apparatus including only a mechanical Denver flotation machine without provision of a minute air bubble generation device as an annex thereto.

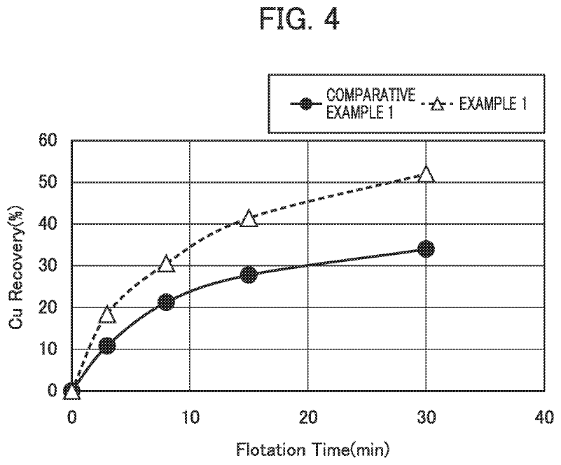

FIG. 4 shows results of the flotation treatment according to each of Example 1 and Comparative Example 1, which is a graph showing a relationship between a flotation duration (flotation time) and Cu recovery. As shown in this graph, it was possible to improve Cu recovery according to Example 1 in which the minute air bubble generation device was provided as an annex to introduce “minute air bubbles” into ore slurry and air bubbles having a larger size than the minute air bubbles were also introduced. At Cu recovery of 30%, for example, a flotation duration was about 8 minutes according to Example 1 and a flotation duration was about 30 minutes according to Comparative Example 1, showing that it was possible to shorten a flotation duration considerably according to Example 1.

### Example 2, Comparative Example 2

According to Example 2, except that a flotation apparatus having the schematic configuration shown in FIG. 3 was used as a flotation apparatus, a treatment same as that of Example 1 was performed. Specifically, in the apparatus used as the flotation apparatus, compressors respectively connected to a flotation device (mechanical Denver flotation machine) and a minute air bubble generation device were provided separately.

A mechanical Denver flotation machine was used as the flotation device. Minute air bubbles having a diameter from 100 to 150 μm (“minute air bubbles”) were generated from the minute air bubble generation device. Air bubbles having a larger diameter (diameter from 1.0 to 1.5 mm) than the minute air bubbles were generated from the mechanical Denver flotation machine. The respective flow rates of the air bubbles generated from the minute air bubble generation device and the air bubbles generated from the mechanical Denver flotation machine could be regulated.

On the other hand, like in Comparative Example 1, a flotation treatment performed as Comparative Example 2 was a conventional treatment using an apparatus including only a mechanical Denver flotation machine without provision of a minute air bubble generation device as an annex thereto.

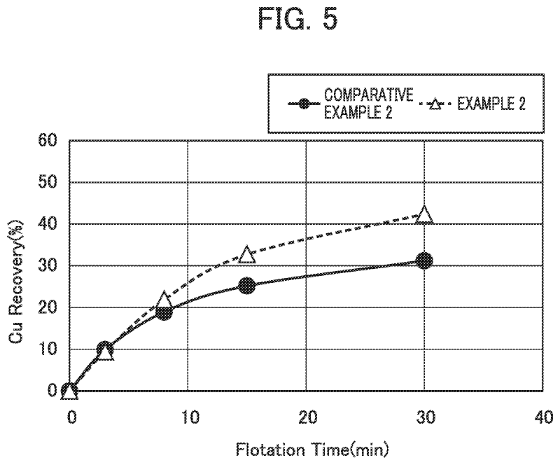

FIG. 5 shows results of the flotation treatments according to Example 2 and Comparative Example 2, which is a graph showing a relationship between a flotation duration (flotation time) and Cu recovery. As shown in this graph, it was possible to improve Cu recovery according to Example 2. Furthermore, it was possible to shorten a flotation duration considerably.

### Example 3, Comparative Example 3

According to Example 3, except that “minute air bubble containing water” containing minute air bubbles added in advance to a mixed powder-particle material having the composition shown in Table 1 was mixed into a liquid to be treated, a treatment same as those of Example 2 was performed. As the minute air bubbles are added in advance, the containing water mainly includes ultrafine bubbles equal to or less than 1 μm. On the other hand, a flotation treatment performed as Comparative Example 3 was a conventional treatment using an apparatus including only a mechanical Denver flotation machine without using minute air bubble containing water.

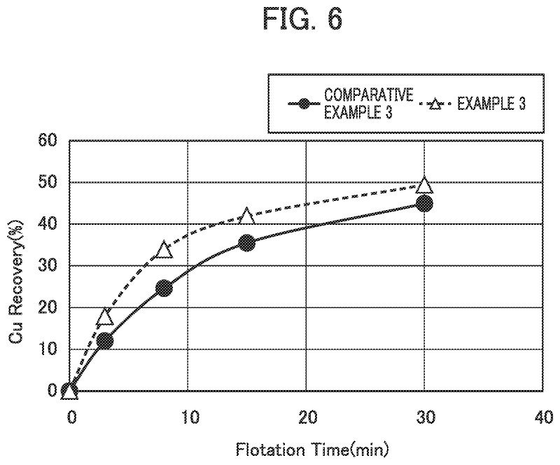

FIG. 6 shows results of the flotation treatments according to Example 3 and Comparative Example 3, which is a graph showing a relationship between a flotation duration (flotation time) and Cu recovery. As shown in this graph, in comparison to Comparative Example 3, it was also possible to improve Cu recovery at a flotation duration of 30 minutes according to Example 3.

### EXPLANATION OF REFERENCE NUMERALS

1A, 1B Flotation system
11 Flotation device
12 Minute air bubble generation device
13, 14 Decompression vale (flow rate valve)
15, 16 Connection pipe
2, 2a, 2b Pressurized gas supply device (compressor)

1. A flotation method of separating and recovering mineral particles through a flotation treatment, the flotation treatment including floating the mineral particles in a liquid to be treated containing the mineral particles, by using minute air bubbles having an air bubble diameter equal to or less than 200 μm and air bubbles having a larger diameter than the minute air bubbles in the liquid to be treated.

2. The flotation method according to claim 1, wherein the minute air bubbles are minute air bubbles equal to or greater than 11 μm and equal to or less than 200 μm.

3. The flotation method according to claim 1, wherein a minute air bubble generation device is provided as an annex to a flotation device and the minute air bubbles are generated in the liquid to be treated from the minute air bubble generation device, and the air bubbles having a larger diameter than the minute air bubbles are generated in the liquid to be treated from the flotation device.

4. The flotation method according to claim 3, comprising regulating the respective flow rates of the minute air bubbles and the air bubbles having a larger diameter than the minute air bubbles in the liquid to be treated.

5. The flotation method according to claim 4, wherein the minute air bubble generation device and the flotation device are individually provided with flow rate valves to allow the flow rate of the air bubbles to be generated from each of the devices to be individually regulated.

6. The flotation method according to claim 4, wherein the minute air bubble generation device and the flotation device are individually connected to pressurized gas supply devices.

7. The flotation method according to claim 2, wherein the mineral particles include particles equal to or less than 25 μm.

8. A flotation system that separates and recovers mineral particles through a flotation treatment, comprising:
a minute air bubble generation device that introduces minute air bubbles having an air bubble diameter equal to or less than 200 μm into a liquid to be treated including the mineral particles; and
a flotation device including a flotation tank that stores the liquid to be treated and floats the mineral particles to an upper part of the liquid to be treated inside the tank, and an air bubble generator that introduces air bubbles having a larger diameter than the minute air bubbles into the liquid to be treated.

9. The flotation system according to claim 8, wherein the minute air bubbles are minute air bubbles equal to or greater than 11 μm and equal to or less than 200 μm.

10. The flotation system according to claim 8, wherein the flotation device and the minute air bubble generation device are individually provided with flow rate valves to allow the flow rate of the air bubbles to be generated from each of the devices to be individually regulated.

11. The flotation method according to claim 2, wherein a minute air bubble generation device is provided as an annex to a flotation device and the minute air bubbles are generated in the liquid to be treated from the minute air bubble generation device, and the air bubbles having a larger diameter than the minute air bubbles are generated in the liquid to be treated from the flotation device.

12. The flotation method according to claim 11, comprising regulating the respective flow rates of the minute air bubbles and the air bubbles having a larger diameter than the minute air bubbles in the liquid to be treated.

13. The flotation method according to claim 12, wherein the minute air bubble generation device and the flotation device are individually provided with flow rate valves to allow the flow rate of the air bubbles to be generated from each of the devices to be individually regulated.

14. The flotation method according to claim 5, wherein the minute air bubble generation device and the flotation device are individually connected to pressurized gas supply devices.

15. The flotation method according to claim 12, wherein the minute air bubble generation device and the flotation device are individually connected to pressurized gas supply devices.

16. The flotation method according to claim 3, wherein the mineral particles include particles equal to or less than 25 μm.

17. The flotation method according to claim 4, wherein the mineral particles include particles equal to or less than 25 μm.

18. The flotation method according to claim 5, wherein the mineral particles include particles equal to or less than 25 μm.

19. The flotation method according to claim 6, wherein the mineral particles include particles equal to or less than 25 μm.

20. The flotation system according to claim 9, wherein the flotation device and the minute air bubble generation device are individually provided with flow rate valves to allow the flow rate of the air bubbles to be generated from each of the devices to be individually regulated.
